(19) United States
(12) Patent Application Publication
(10) Pub. No.: US 2021/0016626 A1
(43) Pub. Date: Jan. 21, 2021

(54) AIR CONDITIONER CONTROL SYSTEM

(71) Applicant: GM GLOBAL TECHNOLOGY OPERATIONS LLC, DETROIT, MI (US)

(72) Inventors: Insu Chang, Troy, MI (US); Chen-fang Chang, Bloomfield Hills, MI (US); Jun-mo Kang, Ann Arbor, MI (US)

(21) Appl. No.: 16/511,811

(22) Filed: Jul. 15, 2019

(51) Int. Cl. B60H 1/00

(52) U.S. Cl. CPC B60H 1/00642; B60L 2240/622; B60H 1/00064; B60H 1/00028

(57) ABSTRACT

An air conditioning system for a vehicle includes a compressor, a condenser fluidically connected to the compressor, an evaporator fluidically connected to the compressor and the condenser, an air moving device positioned to direct a flow of air over the evaporator, a route planning module that provides route planning for the vehicle between a first point and a destination, and an air conditioning controller operatively connected to the compressor, the air moving device, the air conditioning controller including a processor and a non-volatile memory, the processor being operable to deactivate the compressor at a selected point before the vehicle reaches the destination.

### INTRODUCTION

The subject disclosure relates to the art of vehicles and, more particularly, to a control system for a vehicle air conditioner system.

Most modern automobiles include an air conditioning system that cools internal vehicle spaces. In an air conditioner, refrigerant is compressed, transformed into a liquid state and passed through a condenser. An air flow is passed over the condenser causing the refrigerant to give up heat and transform into a gas. The gas is passed through an evaporator in a heat exchange relationship with another air flow. The other air flow is passed into interior spaces of the vehicle. The gas may then pass back to the compressor and undergo a stage change back to liquid.

When the air conditioner is shut down, dew may form on the evaporator due to differences between evaporator coil surface temperature and ambient air temperature. The collection of dew or moisture may attract mold that could result in an unhealthy environment. Accordingly, manufactures would be open to exploring systems that mitigate the formation of dew or other moisture on air conditioner surfaces.

### SUMMARY

In one exemplary embodiment, an air conditioning system for a vehicle includes a compressor, a condenser fluidically connected to the compressor, an evaporator fluidically connected to the compressor and the condenser, an air moving device positioned to direct a flow of air over the evaporator, a route planning module that provides route planning for the vehicle between a first point and a destination, and an air conditioning controller operatively connected to the compressor, the air moving device, the air conditioning controller including a processor and a non-volatile memory, the processor being operable to deactivate the compressor at a selected point before the vehicle reaches the destination.

In addition to one or more of the features described herein a global positioning satellite (GPS) receiver is operatively connected to the processor, the route planning module providing an estimated time of arrival of the vehicle at the destination based on data from the GPS receiver.

In addition to one or more of the features described herein one of a wired interface and a wireless communication interface communicates with the processor.

In addition to one or more of the features described herein the one of the wired communication interface and the wireless communication interface comprises a wireless communication protocol.

In addition to one or more of the features described herein the processor is arranged in a mobile electronics device, the processor communicating with the air conditioning controller through the one of the wired and the wireless communication interface.

In addition to one or more of the features described herein the GPS receiver is arranged in the mobile electronics device.

Also discloses is a vehicle including a body having a passenger compartment, and an air conditioning system for establishing a selected climate in the passenger compartment. The air conditioning system includes a compressor, a condenser fluidically connected to the compressor, an evaporator fluidically connected to the compressor and the condenser, an air moving device positioned to direct a flow of air over the evaporator, a route planning module that provides route planning for the vehicle between a first point and a destination, and an air conditioning controller operatively connected to the compressor, the air moving device, the air conditioning controller including a processor and a non-volatile memory, the processor being operable to deactivate the compressor at a selected point before the vehicle reaches the destination.

In addition to one or more of the features described herein a global positioning satellite (GPS) receiver is operatively connected to the processor, the route planning software providing an estimated time of arrival of the vehicle at the destination based on data from the GPS receiver.

In addition to one or more of the features described herein one of a wired interface and a wireless communication interface communicates with the processor.

In addition to one or more of the features described herein the one of the wired communication interface and the wireless communication interface comprises a wireless communication protocol.

In addition to one or more of the features described herein the processor is arranged in a mobile electronics device, the processor communicating with the air conditioning controller through the one of the wired and the wireless communication interface.

In addition to one or more of the features described herein the GPS RECEIVER is arranged in the mobile electronics device.

Further discloses is a method of controlling an air conditioning system in a vehicle, the method including activating a compressor to create a flow of refrigerant through the air conditioning system, directing a flow of air over an evaporator of the air conditioning system, guiding the flow of air into a passenger compartment of the vehicle, determining a destination of the vehicle, and automatically turning off the compressor at a selected distance from the destination.

In addition to one or more of the features described herein determining the destination includes communicating with a route planning system.

In addition to one or more of the features described herein communicating with the route planning system includes passing data between the vehicle and a portable electronic device.

In addition to one or more of the features described herein passing data includes wirelessly communicating with the portable electronic device.

In addition to one or more of the features described communicating with the route planning system includes determining a location of the vehicle with a global positioning satellite (GPS) receiver.

In addition to one or more of the features described herein the method may further include communicating with the GPS receiver to determine an estimated time of arrival at the destination.

In addition to one or more of the features described herein automatically turning off the compressor includes turning off the compressor at a selected time prior to the estimated time of arrival.

In addition to one or more of the features described herein the method may further include detecting a change in the estimated time of arrival, and changing the time to deactivate the compressor based on the change in the estimated time of arrival.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a vehicle including an air conditioning system, in accordance with an exemplary embodiment;

FIG. 2 is a schematic view of the air conditioning system, in accordance with an exemplary embodiment; and

FIG. 3 is a block diagram depicting a method of operating the air conditioning system, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

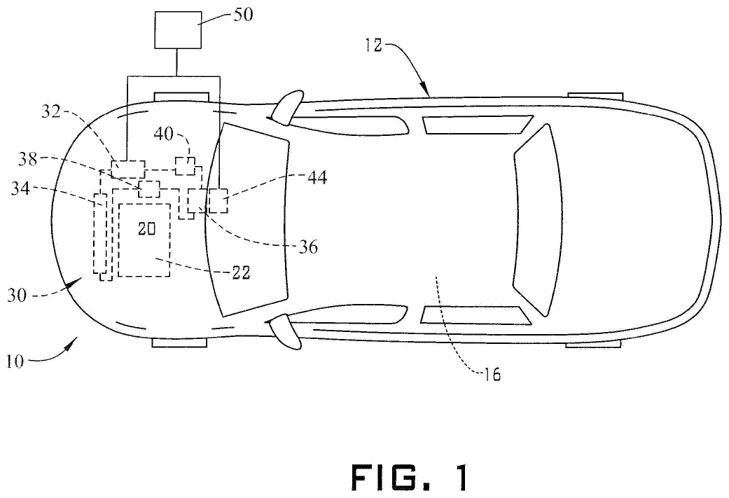

A motor vehicle, in accordance with an exemplary embodiment, is indicated generally at 10 in FIG. 1. Motor vehicle 10 includes a vehicle body 12 defining, at least in part, a passenger or occupant compartment 16. Vehicle body 12 also supports a prime mover 20 that takes the form of an internal combustion engine (ICE) 22. ICE 22 includes a number of pistons (not shown) that are formed from steel or other suitable material. Motor vehicle 10 includes an air conditioning system 30 that may be selectively activated to adjust a climate within passenger compartment 16.

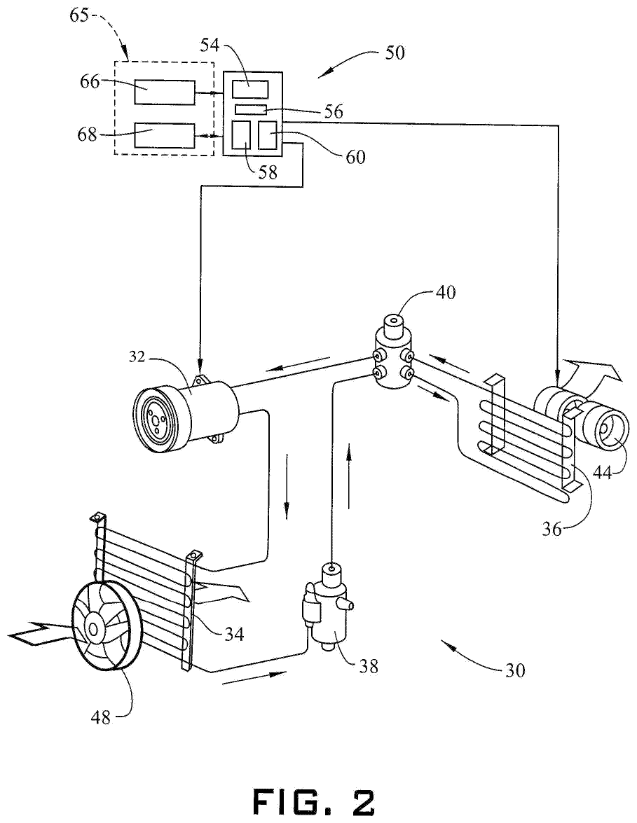

Referring to FIG. 2, and with continued reference to FIG. 1, air conditioning system 30 includes a compressor 32 fluidically connected to a condenser 34 and an evaporator 36. A drier 38 is arranged between and fluidically connected with condenser 32 and evaporator 36. An expansion valve 40 is arranged between and fluidically connected with compressor 32 and evaporator 36. An air moving device 44, such as a blower, may be arranged at evaporator 36. Air moving device 44 directs air across coils (not separately labeled) and into passenger compartment 16. A fan 48 may be arranged at condenser 34 to aid in heat transfer between condenser coils (also not separately labeled) and ambient.

In accordance with an exemplary embodiment, motor vehicle 10 includes an air conditioning controller 50 that operates to reduce moisture in and around evaporator 36 so as to reduce and/or eliminate mold formation. Air conditioning controller 50 is operatively connected to compressor 32 and air moving device 44. As shown in FIG. 2, air conditioning controller 50 includes a central processor unit (CPU) 54 operatively connected to a non-volatile memory 56.

In accordance with one exemplary aspect, air conditioning controller 50 may include a route planning processor or module 58 and a global positioning satellite (GPS) receiver 60. As will be detailed herein, a non-volatile memory 56 may include a set of instructions, which, when executed, shut off compressor 32 and activate air moving device 44 at a selected point along a planned route.

In another exemplary aspect, air conditioning controller 50 may interface with a mobile electronics device 65, such as a smart phone, which includes a route planning processor or module 66 and a global positioning satellite (GPS) receiver 68. Air conditioning controller 50 may communicate with mobile electronics device 65 through a wired connection or a wireless connection, such as Bluetooth® or WiFi. In one example, route planning processor or module 66 may be embodied in Android Auto or Apple Carplay®.

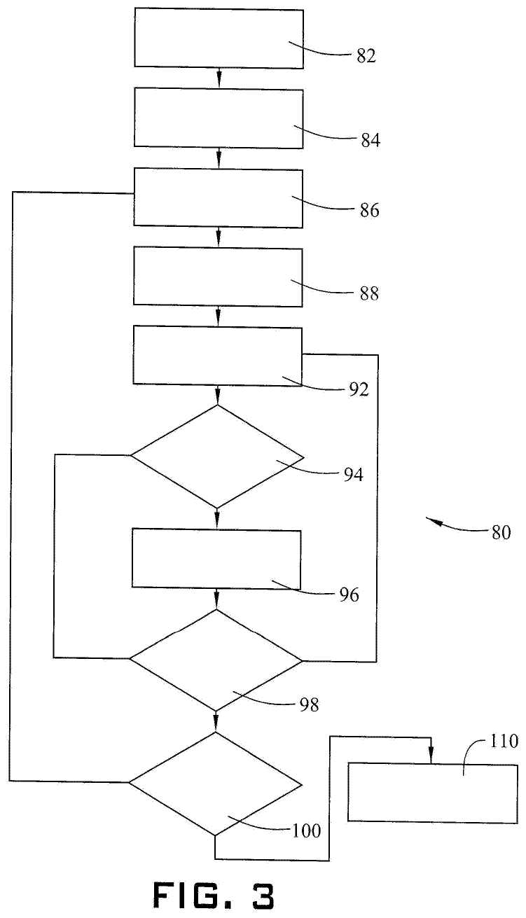

Reference will now follow to FIG. 3 in describing a method 80 of operating air conditioning system 30 in accordance with an exemplary aspect. In block 82, air conditioning system 30 is initialized. At this point, air conditioning controller 50 determines that air conditioning system 30 is working properly. In bock 84, air conditioning controller 50 detects a connection to a GPS receiver; and determines whether a destination has been set. GPS receiver data and route data may come from route planning model 58 and GPS receiver 60 or be received from mobile electronic device 65. In block 86, air conditioning controller 50 determines an estimated time of arrival (ETA) (tₐᵣᵣᵢᵥₐₗ) at the destination. In block 88, air conditioning controller 50 may receive temperature data from a condenser temperature sensor (not shown) and an ambient temperature sensor (also not shown).

At this point, air conditioning controller 50 may determine a time (t_{ac}) that condenser temperature (T^{ac}) is expected to reach a selected percentage of ambient temperature (T^{amb}). For example, air conditioning controller 50 may determine the t_{ac} when T^{ac} is within about 90% of T^{amb}. Typically, during travel t_{ac} is greater than tₐᵣᵣᵢᵥₐₗ. Once t_{ac} is greater than tₐᵣᵣᵢᵥₐₗ, in block 92, air conditioning controller 50 will turn off compressor 32 and maintain operation of air circulating device 44 in order to maintain passenger compartment comfort levels while increasing condenser surface temperature to avoid condensation accumulation.

In block 94, a determination is made whether there is a change in tₐᵣᵣᵢᵥₐₗ. The change may be caused by traffic, construction, stops along the route or unplanned/unexpected delays. If there is a change, tₐᵣᵣᵢᵥₐₗ is updated in block 96. In block 98, a determination is made if the destination has been reached. If the destination has not been reached, method 80 returns to block 92. If the destination has been reached, a determination is made in block 100 if a new destination has been selected. If no new destination is selected, air conditioning controller 50 operates air moving device 44 until T^{ac} is substantially equal to T^{amb} at which point air conditioning controller stops air moving device 44 at block 110. Conversely, if there is no change in tₐᵣᵣᵢᵥₐₗ in block 94, tₐᵣᵣᵢᵥₐₗ is updated and method 80 passes to block 98. Further, if, in block 100 it is determined that a new destination is selected, method 80 returns to block 86.

At this point, it should be understood that exemplary embodiments describe a system for controlling an air conditioning system to reduce moisture formation on an evaporator. The system determines a control point along a planned route to cease operation of a compressor and continue to move air over the evaporator. In this manner, the system may maintain comfortable temperatures within a passenger compartment and, at the same time, move surface temperatures of the evaporator closer to ambient. The system may update the control point to account for trip delays caused by any number of factors including traffic, road construction and the like.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An air conditioning system for a vehicle comprising:
a compressor;
a condenser fluidically connected to the compressor;
an evaporator fluidically connected to the compressor and the condenser;
an air moving device positioned to direct a flow of air over the evaporator;
a route planning module providing route planning for the vehicle between a first point and a destination; and
an air conditioning controller operatively connected to the compressor, the air moving device and the route planning module, the air conditioning controller including a processor and a non-volatile memory, the processor being operable to deactivate the compressor at a selected point before the vehicle reaches the destination.

2. The air conditioning system according to claim 1, further comprising: a global positioning satellite (GPS) receiver operatively connected to the processor, the route planning module providing an estimated time of arrival of the vehicle at the destination based on data from the GPS receiver.

3. The air conditioning system according to claim 2, further comprising: one of a wired interface and a wireless communication interface for communicating with the processor.

4. The air conditioning system according to claim 3, wherein the one of the wired communication interface and the wireless communication interface comprises a wireless communication protocol.

5. The air conditioning system according to claim 3, wherein the processor is arranged in a mobile electronics device, the processor communicating with the air conditioning controller through the one of the wired interface and the wireless communication interface.

6. The air conditioning system according to claim 5, wherein the GPS receiver is arranged in the mobile electronics device.

7. A vehicle comprising:
a body including a passenger compartment; and
an air conditioning system for establishing a selected climate in the passenger compartment, the air conditioning system including:
a compressor;
a condenser fluidically connected to the compressor;
an evaporator fluidically connected to the compressor and the condenser;
an air moving device positioned to direct a flow of air over the evaporator;
a route planning module providing route planning for the vehicle between a first point and a destination; and
an air conditioning controller operatively connected to the compressor, the air moving device and the route planning module, the air conditioning controller including a processor and non-volatile memory, the processor being operable to deactivate the compressor at a selected point before the vehicle reaches the destination.

8. The vehicle according to claim 7, further comprising: a global positioning satellite (GPS) receiver operatively connected to the processor, the route planning module providing an estimated time of arrival of the vehicle at the destination based on data from the GPS receiver.

9. The vehicle according to claim 8, further comprising: one of a wired interface and a wireless communication interface for communicating with the processor.

10. The vehicle according to claim 9, wherein the one of the wired communication interface and the wireless communication interface comprises a wireless communication protocol.

11. The vehicle according to claim 9, wherein the processor is arranged in a mobile electronics device, the processor communicating with the air conditioning controller through the one of the wired and the wireless communication interface.

12. The vehicle according to claim 11, wherein the GPS receiver is arranged in the mobile electronics device.

13. A method of controlling an air conditioning system in a vehicle, the method comprising:
activating a compressor to create a flow of refrigerant through the air conditioning system;
directing a flow of air over an evaporator of the air conditioning system;
guiding the flow of air into a passenger compartment of the vehicle;
determining a destination of the vehicle; and
automatically turning off the compressor at a selected distance from the destination.

14. The method of claim 13, wherein determining the destination includes communicating with a route planning system.

15. The method of claim 14, wherein communicating with the route planning system includes passing data between the vehicle and a portable electronic device.

16. The method of claim 15, wherein passing data includes wirelessly communicating with the portable electronic device.

17. The method of claim 15, wherein communicating with the route planning system includes determining a location of the vehicle with a global positioning satellite (GPS) receiver.

18. The method of claim 17, further comprising: communicating with the GPS receiver to determine an estimated time of arrival at the destination.

19. The method of claim 18, wherein automatically turning off the compressor includes turning off the compressor at a selected time prior to the estimated time of arrival.

20. The method of claim 19, further comprising:
detecting a change in the estimated time of arrival; and
changing the selected time to deactivate the compressor based on the change in the estimated time of arrival.
